(19) United States
(12) Patent Application Publication
(10) Pub. No.: US 2006/0203090 A1
(43) Pub. Date: Sep. 14, 2006

(54) Video surveillance using stationary-dynamic camera assemblies for wide-area video surveillance and allow for selective focus-of-attention

(75) Inventors: Yuan-Fang Wang, Goleta, CA (US); Edward Chang, Santa Barbara, CA (US); Ken Prayoon Cheng, Saratoga, CA (US)

Correspondence Address: Bo-In Lin, 13445 Mandoli Drive, Los Altos Hills, CA, 94022, US

(73) Assignee: PROXIMEX, CORPORATION

(21) Appl. No.: 11/293,533

(22) Filed: Dec. 3, 2005

Related U.S. Application Data
(60) Provisional application No. 60/633,166, filed on Dec. 4, 2004.

(51) Int. Cl. H04N 7/18; H04N 9/47

(52) U.S. Cl. 348/143

(57) ABSTRACT

A video surveillance system includes multiple video cameras. The surveillance system is configured with an arrangement to separate the surveillance functions and assign different surveillance functions to different cameras. A master camera is assigned the surveillance of large area surveillance and tracking of object movement while one or more slave cameras are provided to dynamically rotate and adjust focus to obtain clear image of the moving objects as detected by the master camera. Algorithms to adjust the focus-of-attention are disclosed to effectively carry out the tasks by a slave camera under the command of a master camera to obtain images of a moving object with clear feature detections.

This application is a Formal Application and claims priority to pending U.S. patent application entitled “VIDEO SURVEILLANCE USING STATIONARY-DYNAMIC CAMERA ASSEMBLIES FOR WIDE-AREA VIDEO SURVEILLANCE AND ALLOW FOR SELECTIVE FOCUS-OF-ATTENTION” filed on Dec. 4, 2004 and accorded Ser. No. 60/633,166 by the same Applicant of this Application, the benefit of its filing date being hereby claimed under Title 35 of the United States Code.

### BACKGROUND OF THE INVENTION

1. Field of the Invention

This invention relates generally to methods and system configurations for designing and implementing video surveillance systems. More particularly, this invention relates to an improved off-line calibration process and an on-line selective focus-of-attention procedure for providing wide-area video-based surveillance and select focus-of-attention for a surveillance system using dynamic-stationary camera assemblies. The goal is to enhance the functionality of such a surveillance system with both static and dynamic surveillance to provide improved dynamic tracking with increased resolution to effectively provide more secured protections of limited access.

2. Description of the Prior Art

Conventional system configurations and methods for providing security surveillance of limited access areas are still confronted with difficulties that the video images having poor resolution and very limited flexibly are allowed for control of tracking and focus adjustments. Existing surveillance systems implemented with video cameras are provided with object movement tracking capabilities to follow the movements of persons or objects. However, the resolution and focus adjustments are often inadequate to provide images of high quality to effectively carry out the necessary security functions currently required for the control of access to the protected areas.

There has been a surge in the number of surveillance cameras put in service in the last two years since the September 11th attacks. Closed Circuit Television (CCTV) has grown significantly from being used by companies to protect personal property to becoming a tool used by law enforcement authorities for surveillance of public places. US policymakers, especially in security and intelligence services, are increasingly turning toward video surveillance as a means to combat terrorist threats and a response to the public's demand for security. However, important research questions must be addressed before the video surveillance data can reliably provide an effective tool for crime prevention.

In carrying out video surveillance to achieve a large area of coverage with a limited supply of hardware, it is often desirable to configure the surveillance cameras in such a way that each camera watches over an extended area. However, if suspicious persons/activities are identified through video analysis, it is then often desirable to obtain close-up views of the suspicious subjects for further scrutiny and potential identification (e.g., to obtain a close-up view of the license plate of a car or the face of a person). These two requirements (a large field-of-view and the ability of selective focus-of-attention) oftentimes place conflicting constraints on the system configuration and camera parameters. For instance, a large field-of-view is achieved using a lens of a short focal length while selective focus-of-attention requires a lens of a long focal length.

Specifically, since any trespass into a limited access area has dynamically changing circumstances with persons and objects continuously moving, the ability to perform dynamic tracking of movement to determine the positions of persons and objects and to carry out focus adjustment according to these positions are critical. Additionally, methods and configurations must be provided to produce clear images with sufficient resolutions such that required identity checking and subsequent secured actions may be taken accordingly.

Venetianer, et al. disclose in U.S. Pat. No. 6,696,945, entitled “Video Tripwire”, a method for implementing a video tripwire. The method includes steps of calibrating a sensing device to determine sensing device parameters for use by a control computer. The controlling computer system then performs the functions of initializing the system that includes entering at least one virtual tripwire; obtaining data from the sensing device; analyzing the data obtained from the sensing device to determine if the at least one virtual tripwire has been crossed; and triggering a response to a virtual tripwire crossing. Venetianer et al. however do not provide a solution to the difficulties faced by the conventional video surveillance systems that the video surveillance systems are unable to obtain clear images with sufficient resolution of a dynamically moving object.

A security officer is now faced with a situation that frequently requires him to monitor different security areas. On the one hand, it is necessary to monitor larger areas to understand the wide field of view. On the other hand, when there is suspicious activity, it is desirable in the meantime to use another camera or the same camera to zoom in on the activity and try to gather as much information as they can about the suspects. Under these circumstances, the conventional video surveillance technology is still unable to provide an automated way to assist a security officer to effectively monitor secure areas.

Therefore, a need still exists in the art to of video surveillance of protected areas with improved system configurations and attention of focus adjustments keeping in synchronization with dynamic tracking of movements such that the above-mentioned difficulties and limitations may be resolved.

### SUMMARY OF THE PRESENT INVENTION

It is therefore an object of the present invention to provide improved procedures and algorithms for calibrating and operating stationary-dynamic camera assemblies in a surveillance system to achieve wide-area coverage and selective focus-of-attention.

It is another object of the present invention to provide an improved system configuration for configuring a video surveillance system that includes a stationary-dynamic camera assembly operated in a cooperative and hierarchical process such that the above discussed difficulties and limitations can be overcome.

Specifically, this invention discloses several preferred embodiment implemented with procedures and software modules to provide accurate and efficient results for calibrating both stationary and dynamic cameras in a camera assembly and will allow a dynamic camera to correctly focus on suspicious subjects identified by the companion stationary cameras.

Particularly, an object of this invention is to provide an improved video surveillance system by separating the surveillance functions and by assigning different surveillance functions to different cameras. A stationary camera is assigned the surveillance of a large area and tracking of object movement while one or more dynamic cameras are provided to dynamically rotate and adjust focus to obtain clear images of the moving objects as detected by the stationary camera. Algorithms to adjust the focus-of-attention are disclosed to effectively carry out the tasks by a dynamic camera under the command of a stationary camera to obtain images of a moving object with clear feature detections.

Briefly, in a preferred embodiment, the present invention includes (1) an off-line calibration module, and (2) an on-line focus-of-attention module. The offline calibration module positions a simple calibration pattern (a checkerboard pattern) at multiple distances in front of the stationary and dynamic cameras. The 3D coordinates and the corresponding 2D image coordinates are used to infer the extrinsic and intrinsic camera parameters. The on-line process involves identifying a target (e.g., a suspicious person identified by the companion stationary cameras through some pre-defined activity analysis) and then uses the pan, tilt, and zoom capabilities of the dynamic camera to correctly center on the target and magnify the target images to increase resolution.

In another preferred embodiment, the present invention includes a video surveillance system that utilizes at least two video cameras performing surveillance by using a cooperative and hierarchical control process. In a preferred embodiment, the two video cameras include a first video camera functioning as a master camera for commanding a second video camera functioning as a slave camera. A control processor controls the functioning the cameras and this control processor may be embodied in a computer. In a preferred embodiment, at least one of the cameras is mounted on a movable platform. In another preferred embodiment, at least one of the cameras has flexibility of multiple degrees of freedoms (DOFs) that may include a rotational freedom to point to different angular directions. In another preferred embodiment, at least one of the cameras is provided to receive a command from anther camera to automatically adjust a focus length. In another preferred embodiment, the surveillance system includes at least three cameras and arranged in a planar or co-linear configuration. In another preferred embodiment, the surveillance comprises at least three cameras with one stationary camera and two dynamic cameras disposed on either sides of the stationary camera.

This invention discloses a method for off-line calibration using an efficient, robust, and closed-form numerical solution and a method for on-line selective focus-of-attention using a visual servo principle. In particular, the calibration procedure will, for stationary and dynamic cameras, correctly compute the camera's pose (position and orientation) in the world coordinate system and will estimate the focal length of the lens used, and the aspect ratio and center offset of the camera's CCD. The calibration procedure will, for dynamic cameras, correctly and robustly estimate the pan and tilt degrees-of-freedom, including axis position, axis orientation, and angle of rotation as functions of focal length. The selective focus-of-attention procedure will compute the correct pan and tilt maneuvers needed to center a suspect in the dynamic cameras, regardless if the optical center is located on the rotation axes and if the rotation axes are properly aligned with the width and height of the camera's CCD array.

In a preferred embodiment, this invention further discloses a method for configuring a surveillance video system by arranging at least two video cameras with one of the cameras functioning as a stationary camera to command and direct a dynamic camera to move and adjust focus to obtain detail features of a moving object.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1A is a system diagram of a stationary-dynamic video surveillance system of this invention.

FIG. 1B is a system diagram of a single camera enabled to perform the stationary-dynamic video surveillance functions processed and controlled by a surveillance controller of this invention.

FIGS. 2A and 2B are diagrams for illustrating the computations of the correct pan DOF if optical and pan centers are collocated, and if the optical and pan centers are not collocated respectively.

FIG. 3 is a diagram for showing the errors in centering with an assumption of computational collocation of the optical center on the rotation axis

FIG. 4 is a system diagram for illustrating a feedback control loop implemented in a preferred embodiment for controlling the master and slave cameras of this invention.

FIGS. 5A to 5C are diagrams for showing respectively (a) the relation between requested and realized angle of rotation for Sony PTZ camera, (b) the mean projection error as a function of pan angle, and (c) the mean projection error as a function of depth for our model and naïve models.

FIGS. 6A to 6D are diagrams for showing the centering errors under different kinds of surveillance measurement conditions.

FIG. 7A to 7D are surveillance video images before and after the calibration of the surveillance system applying the on-line servo control algorithms disclosed in this invention.

### DETAILED DESCRIPTION OF THE PREFERRED EMBODIMENT

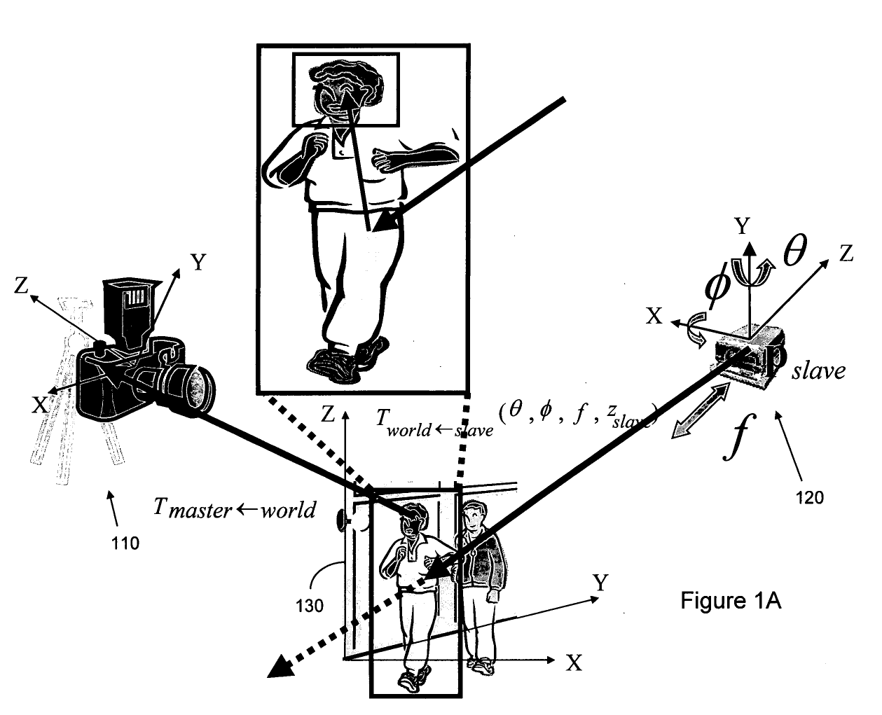

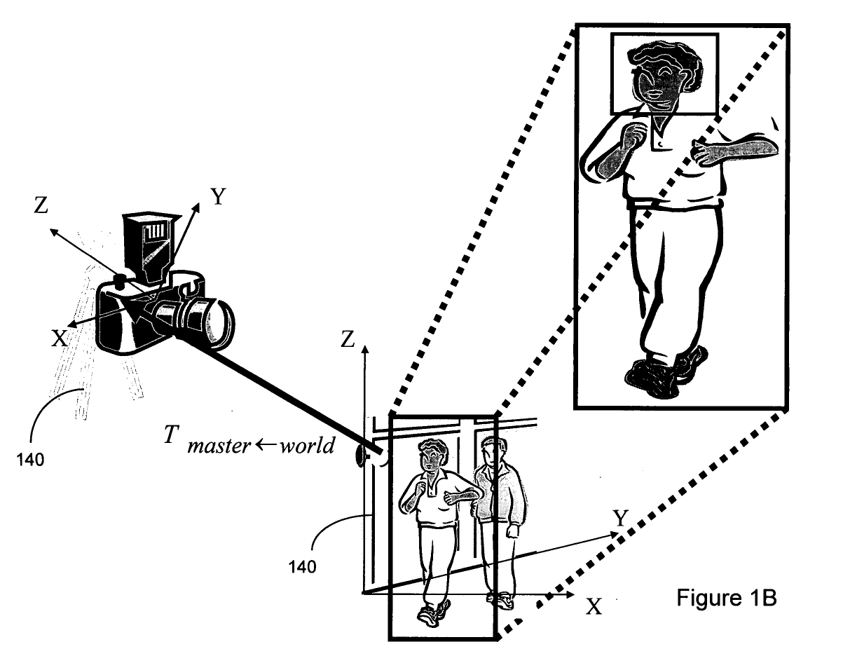

Referring to FIG. 1A for a preferred embodiment of this invention to address the problem of selective focus-of-attention. The surveillance system is configured to include a stationary-dynamic that may be implemented as a master-slave camera assembly for video surveillance. The camera assembly includes a stationary, e.g., a master camera 110, and a dynamic, e.g., a slave camera 120, for carrying out a video surveillance of an area that includes a gate 130 where two persons are entering the area of surveillance. As will be discussed further below, the selective focus-of-attention configuration implemented in this camera assembly is able to provide an image of each individual moving object with improved resolution. The master camera 110 performs a global, wide field-of-view analysis of the motion patterns in a surveillance zone. The slave camera 120 is then directed by the master camera to obtain detail views of the subjects and behaviors under the guidance of the master camera 110. FIG. 1B shows an alternate preferred embodiment with a dynamic camera 140 controlled by a video-surveillance controller (not shown) to dynamically carry out the functions performed by the stationary-dynamic cameras as shown in FIG. 1A and described below.

Specifically, the scenario addressed in this application is one where multiple cameras, or multiple camera surveillance functions carried out by a single camera processed by a surveillance controller, are used for monitoring an extended surveillance area. This can be an outdoor parking lot, an indoor arrival/departure lounge in an airport, a meeting hall in a hotel, etc. In order to achieve a large area of coverage with a limited supply of hardware, it is often desirable to configure the surveillance cameras in such a way that each camera covers a large field of view. However, if suspicious persons/activities are identified through video analysis, it then often desirable to obtain close-up views of the suspicious subjects for further scrutiny and potential identification, e.g., to obtain a close-up view of the license plate of a car or the face of a person. These two requirements, i.e., a large field of view and the ability of selective focus-of-attention, oftentimes impose conflicting constraints on the system configuration and camera parameters. For instance, a large field-of-view is achieved using a lens of a short focal length while selective focus-of-attention requires a lens of a long focal length.

To satisfactorily address these system design issues, a system configuration as disclosed in a preferred embodiment is to construct highly-compartmentalized surveillance stations and employ these stations in a cooperative and hierarchical manner to achieve large areas of coverage and selective focus-of-attention. In the present invention, an extended surveillance area, e.g., an airport terminal building will be partitioned into partially overlapped surveillance zones. While the shape and size of a surveillance zone depend on the particular locale and the number of stationary cameras used and their configuration may vary, the requirement is that the fields-of-view of the stationary cameras deployed should cover, collectively, the whole surveillance area (a small amount of occlusion by architectural fixtures, decoration, and plantation is unavoidable) and overlap partially to facilitate registration and correlation of events observed by multiple cameras.

Within each surveillance zone, multiple camera groups, e.g., at least one group, should be deployed. Each camera group will comprise at least one stationary camera and multiple, e.g., at least one, dynamic cameras. The cameras in the same group will be hooked up to a PC or multiple networked PCs, which performs a significant amount of video analysis. The stationary camera will have a fixed platform and fixed camera parameters such as the focal length. The dynamic cameras will be mounted on a mobile platform. The platform should provide at least the following degrees of freedom: two rotational degrees of freedom (DOFs) and another DOF for adjusting the focal length of the camera. Other DOFs are desirable but optional. As disclosed in this Application, it is assumed that the rotational DOFs comprise a pan and a tilt. When the camera is held upright, the panning DOF corresponds to roughly a “left-right” rotation of the camera body and the tilting DOF corresponds to roughly a “top-down” rotation of the camera body. However, there is no assumption that such “left-right” and “top-down” motion has to be precisely aligned with the width and height of the camera's CCD array, and there is no assumption that the optical center has to be on the rotation axes.

The relative position of the stationary and dynamic cameras may be collinear or planar for the sake of simplicity. For example, when multiple dynamic cameras are deployed, they could be on the two sides of the stationary one. If more than two dynamic cameras are deployed, some planar grid configuration, with the stationary camera in the center of the grid and dynamic cameras arranged in a satellite configuration around the stationary, should be considered. The exact spacing among the cameras in a camera group can be locale and application dependent. One important tradeoff is that there should be sufficient spacing between cameras to ensure an accurate depth computation while maintaining a large overlap of the fields-of-view of the cameras. The deployment configuration of multiple camera groups in the same surveillance zone is also application-dependent. However, the placement is often dictated by the requirement that collectively, the fields-of-view of the cameras should cover the whole surveillance zone area. Furthermore, the placement of camera groups in different zones should be such that some overlap exists between the fields-of-view of the cameras in spatially adjacent zones. This will ensure that motion events can be tracked reliably across multiple zones and smooth handoff policies from one zone to the next can be designed.

As a simple example, in an airport terminal building with multiple terminals, each surveillance zone might comprise the arrival/departure lounge of a single terminal. Multiple camera groups can be deployed within each zone to ensure a complete coverage. Another example is that multiple camera groups can be used to cover a single floor of a parking structure, with different surveillance zones designated for different floors.

Technical issues, related to the configuration, deployment, and operation of a multi-camera surveillance system as envisioned above, are disclosed and several of these issued are addressed in this Patent Application. To name a few of them:

Issues Related to the Configuration of the System

1. How to optimally configure the stationary and dynamic cameras in the same camera group to allow information sharing and cooperative sensing.
2. How to optimally configure multiple camera groups covering the same surveillance zone to ensure full coverage of the events in the zone and minimize occlusion and blind spots.
3. How to optimally configure the cameras in adjacent surveillance zones to ensure a smooth transition of sensing activities and uninterrupted event tracking across multiple zones.
   Issues Related to the Deployment of the System
4. How to calibrate individual dynamic cameras given that the camera parameters may change with respect to time due to pan, tilt, and change of focus actions.
5. How to calibrate the cameras so that multiple camera coordinate systems can be related to each other (spatial registration).
6. How to synchronize the cameras so that events reported by multiple cameras (or surveillance stations) can be correlated (temporal synchronization).
7. How to calibrate the cameras in such a way that the ensuing image analysis can be made immune to lighting changes, shadow, and variation in weather condition.
   Issues Related to the Operation of the System
8. How to use the stationary camera to guide the sensing activities of the dynamic cameras to achieve purposeful focus-of-attention.
9. How to achieve data fusion and information sharing among multiple camera groups in the same surveillance zone for event detection, representation, and recognition.
10. How to maintain event tracking and relay information across multiple surveillance zones.
11. How to reliably perform identification of license plate numbers or face recognition.
12. How to minimize power consumption and bandwidth usage for coordinating sensing and reporting activities of the camera network.

Some of the preferred embodiments of this Patent Application disclose practically implementations and methods to operate the stationary-dynamic cameras in the same camera group to achieve selective and purposeful focus-of-attention. Extension of these disclosures to multiple groups certainly falls within the scopes of this invention. As the disclosures below may address some of the issues in particular, the solutions to all other issues are likely covered by the scope as well since the solutions to deal with the remaining issues may be dealt with manually by those of ordinary skill in the art after reviewing and understand the disclosures made in the disclosures of this Patent Application.

For practical implementations, it is assumed that the stationary camera 110 performs a global, wide field-of-view analysis of the motion patterns in a surveillance zone. Based on some pre-specified criteria, the stationary camera is able to identify suspicious behaviors and subjects that need further attention. These behaviors may include loitering around sensitive or restricted areas, entering through an exit, leaving packages behind unattended, driving in a zigzag or intoxicated manner, circling an empty parking lot or a building in a suspicious, reconnoitering way, etc. The question is then how to direct the dynamic cameras to obtain detailed views of the subjects/behaviors under the guidance of the master.

Briefly, the off-line calibration algorithm discloses a closed-form solution that accurately and efficiently calibrates all DOFs of a pan-tilt-zoom (PTZ) dynamic camera. The on-line selective focus-of-attention is formulated as a visual servo problem. The formulation has special advantages that the formulation is applicable even with dynamic changes in scene composition and varying object depths, and does not require tedious and time-consuming calibration as others.

In this particular application, video analysis and feature extraction processes are not described in details as these analyses and processes are disclosed in several standard video analysis, tracking, and localization algorithms. More details are described below on the following two techniques: (1) an algorithm for camera calibration and pose registration for both the stationary and dynamic cameras, and (2) an algorithm for visual servo and error compensation for selective focus-of-attention.

In order to better understand the video surveillance and video camera calibration algorithms disclosed below, background technical information is first provided below. Extensive research has been conducted in video surveillance. To name a few works, the Video Surveillance and Monitoring (VSAM) project R. Collins, A. Lipton, H. Fujiyoshi, T. Kanade, “Algorithms for Cooperative Multisensor Surveillance,” Proceedings of IEEE, Vol. 89, 2001, pp. 1456-1477 at CMU has developed a multi-camera system that allows a single operator to monitor activities in a cluttered environment using a distributed sensor network. This work has laid the technological foundation for a number of start-up companies. The Sphinx system by Gang Wu, Yi Wu, Long Jiao, Yuan-Fang Wang, and Edward Chang “Multi-camera Spatio-temporal Fusion and Biased Sequence-data Learning for Security Surveillance,” Proceedings of the ACM Multimedia Conference, Berkeley, Calif., 2003, reported by researchers at the University of California, is a multi-camera surveillance system that addresses motion event detection, representation, and recognition for outdoor surveillance. W4 I. Haritaoglu, D. Karwood, and L. S. Davis, “W4: Real-time Surveillance of People and Their Activities,” IEEE Transactions PAMI, Vol. 22, 2000, pp. 809-830, from the University of Maryland, is a real-time system for detecting and tracking people and their body parts. Pfinder C. R. Wren, A. Azarbayejani, T. J. Darrel, and A. P. Petland, “Pfinder: Real-time Tracking of the Human Body,” IEEE Transactions on PAMI, Vol. 19, 1997, pp. 780-785, developed at MIT, is another people-tracking and activity-recognition system. J. Ben-Arie, Z. Wang, P. Pandit, and S. Rajaram, “Human Activity Recognition Using Multidimensional Indexing”, IEEE Transactions on PAMI, Vol. 24, 2002 presents another system for analyzing human activities using efficient indexing techniques. More recently, a number of workshops and conferences ACM 2nd International Workshop on Video Surveillance and Sensor Networks, New York, 2004 and IEEE Conference on Advanced Video and Signal Based Surveillance, Miami, Fla., 2003 have been organized to bring together researchers, developers, and practitioners from academia, industry, and government, to discuss various issues involved in developing large-scale video surveillance networks.

As discussed above, many issues related to image and video analysis need to be addressed satisfactorily to enable multi-camera video surveillance. A comprehensive survey of these issues will not be presented in this application; instead, solutions that address two particular challenges, i.e., 1) off-line calibration and 2) the on-line selective focus-of-attention issues, are disclosed in details below. These two technical challenges have been well understood as critical to the use of stationary-dynamic camera assemblies for video surveillance. The disclosures made in this invention addressing these two issues can therefore provide new and improved solutions that are different and in clear contrast with those of the state-of-the-art methods in these areas.

J. Davis and X. Chen, “Calibrating Pan-Tilt Cameras in Wide-area Surveillance Networks,” Proceedings of ICCV, Nice, France, 2003 presented a technique for calibrating a pan-tilt camera off-line. This technique adopted a general camera model that did not assume that the rotational axes were orthogonal or that they were aligned with the imaging optics of the cameras. Furthermore, Davis and Chen argued that the traditional methods of calibrating stationary cameras using a fixed calibration stand were impractical for calibrating dynamic cameras, because a dynamic camera had a much larger working volume. Instead, a novel technique was adopted to generate virtual calibration landmarks using a moving LED. The 3D positions of the LED were inferred, via stereo triangulation, from multiple stationary cameras placed in the environment. To solve for the camera parameters, an iterative minimization technique was proposed.

Zhou et al. X. Zhou, R. T. Collins, T. Kanade, P. Metes, “A Master-Slave System to Acquire Biometric Imagery of Humans at Distance,” Proceedings of 1^{st} ACM Workshop on Video Surveillance, Berkeley, Calif., 2003 presented a technique to achieve selective focus-of-attention on-line using a stationary-dynamic camera pair. The procedure involved identifying, off-line, a collection of pixel locations in the stationary camera where a surveillance subject could later appear. The dynamic camera was then manually moved to center on the subject. The pan and tilt angles of the dynamic camera were recorded in a look-up table indexed by the pixel coordinates in the stationary camera. The pan and tilt angles needed for maneuvering the dynamic camera to focus on objects that appeared at intermediate pixels in the stationary camera were obtained by interpolation. At run time, the centering maneuver of the dynamic camera was accomplished by a simple table-look-up process, based on the locations of the subject in the stationary camera and the pre-recorded pan-and-tilt maneuvers.

Compared to the state-of-the-art methods surveyed above, new techniques are disclosed in this invention in dealing with off-line camera calibration and on-line selective focus of attention as further described below:

In terms of off-line camera calibration:
1. It is well known that three pieces of information are needed to uniquely define a rotation (e.g., pan and tilt): position of the rotation axis, orientation of the axis, and rotation angle. Although Davis and Chen assume this general model, it explicitly calibrates only the position and orientation of the axis. In contrast to these methods, the present invention discloses techniques to calibrate parameters for video surveillance along all these DOFs.
2. The work of Davis and Chen calibrates only pan and tilt angles, whereas the disclosures made in this Application provide technique that is applicable to camera zoom as well (camera zoom does change the position of the optic center). Accurately calibrating the relative positions of the optical center and the rotation axes is particularly important for dynamic cameras operating in high zoom settings, e.g., for close scrutiny of suspicious subjects. In a high zoom setting, one can easily lose track of a subject if parameters employed for video surveillance are poorly calibrated.
3. The technique of Davis and Chen uses an iterative minimization procedure that is computationally expensive. The present invention discloses technique to obtain solutions for all intrinsic and extrinsic camera parameters for both stationary and dynamic cameras using a closed-form solution that is both efficient and accurate. Accurate solution when achievable with less intensive computation requirements allow for flexibilities to implement inexpensive and less accurate PTZ platforms to host dynamic cameras in a large surveillance system.
4. While the virtual landmark approach in Davis and Chen is interesting, as will be further discussed below that such a technique is less accurate than the traditional techniques using a small calibration pattern, e.g., a checkerboard pattern. Compared to the technique disclosed in Davis and Chen, traditional techniques can also provide large angular ranges for calibrating pan and tilt DOFs effectively.

In terms of on-line selective focus-of-attention:
1. In order for the procedure proposed in Zhou et al. to work, surveillance subjects must appear at the same depth each time they appear at a particular pixel location in the stationary camera. This assumption is unrealistic in real-world applications. The technique disclosed in this invention does not impose this constraint, but allows surveillance subjects to appear freely in the environment with varying depths.
2. Manually building a table of pan and tilt angles is a time-consuming process Zhou et al. Furthermore, the process needs to be repeated at each surveillance location, and it will fail if the environmental layout changes later. The technique disclosed in this invention does not use such a “static” look-up table, but automatically adapts to different locales.
3. The techniques disclosed in this Application are applicable even with high and varying camera zoom settings and poorly aligned pan and tilt axes.
   Technical Rationales
   Off-Line Calibration
   Stationary Cameras: Because the setting of a master camera is held stationary, its calibration is performed only once, off-line. Many calibration algorithms are available. Here, for the sake of completeness, a short description of the algorithm implemented in the surveillance system as a preferred embodiment is described. Further descriptions of the enhancement of this calibration algorithm to address the parametric calibration of dynamic cameras will be provided later.

Generally speaking, all camera-calibration algorithms model the image formation process as a sequence of transformations plus a projection. The sequence of operations brings a 3D coordinate P_{world}, specified in some global reference frame, to a 2D coordinate Pᵣₑₐₗ, specified in some camera coordinate frame (both in homogeneous coordinates). The particular model that implemented in a preferred embodiment is shown below.

$$\begin{matrix}{p}_{real} = {M}_{real ← ideal} {M}_{ideal ← camera} {M}_{camera ← world} {P}_{world} \\ = [ \begin{matrix}{fk}_{u} & 0 & {u}_{o} \\ 0 & {fk}_{v} & {v}_{o} \\ 0 & 0 & 1\end{matrix} ] [ \begin{matrix}1 & 0 & 0 & 0 \\ 0 & 1 & 0 & 0 \\ 0 & 0 & 1 & 0\end{matrix} ] [ \begin{matrix}{r}_{1}^{T} & - {T}_{x} \\ {r}_{2}^{T} & - {T}_{y} \\ {r}_{3}^{T} & - {T}_{z} \\ 0 & 1\end{matrix} ] {P}_{world}\end{matrix}$$

The process can be decomposed into three stages:
M_{camera←world} A world-to-camera coordinate transform: This is represented as a 4×4 matrix in homogeneous coordinates that maps 3D coordinates (in a homogeneous form) specified in a global reference frame to 3D coordinates (again in a homogeneous form) in a camera-(or viewer-) centered reference frame. This transformation is uniquely determined by a rotation (r₁^{T}, r₂^{T}, r₃^{T} represent the rows of the rotation matrix), and a translation (Tₓ, T_{y}, T_{z}).
M_{ideal←camera} A camera-to-ideal image projective transform: This is specified as a 3×4 matrix in homogeneous coordinates that projects 3D coordinates (in a homogeneous form) in the camera reference frame onto the image plane of an ideal (a pinhole) camera. The model can be perspective, paraperspective, or weak perspective, which models the image formation process with differing degrees of fidelity. In a preferred embodiment, it implements a full perspective model. This matrix is of a fixed form with no unknown parameter, determined entirely by the perspective model used.
M_{real←ideal} An ideal image-to-real image transform: This is specified as a 3×4 matrix in homogeneous coordinates that changes ideal projection coordinates into real camera coordinates. This process accounts for physical camera parameters (e.g., the center location u₀ and v₀ of the image plane and the scale factors kᵤ and kᵥ in the x and y directions) and the focal length (f) in the real-image formation process.

If enough known calibration points are used, all these parameters can be solved for. Many public-domain packages and free software, such as OpenCV have routines for stationary camera calibration.

Dynamic Cameras: Calibrating a pan-tilt-zoom (PTZ) camera is more difficult, as there are many variable DOFs, and the choice of a certain DOF, e.g., zoom, affects the others.

The pan and tilt DOFs correspond to rotations, specified by the location of the rotation axis, the axis direction, and the angle of rotation. Furthermore, the ordering of the pan and tilt operations is important because matrix multiplication is not commutative except for small rotation angles. A camera implemented in a surveillance system can be arranged with two possible designs: pan-tilt (or pan before tilt) and tilt-pan (or tilt before pan). Both designs are widely used, and the calibration formulation as described below is applicable to both designs.

Some simplifications can make the calibration problems slightly easier, but at the expense of a less accurate solution. The simplifications are (1) collocation of the optical center on the axes of pan and tilt, (2) parallelism of the pan and tilt axes with the height (y) and width (x) dimensions of the CCD, and (3) the requested and realized angles of rotation match, or the angle of rotation does not require calibration. For example, Davis and Chen may assume that (3) is true and calibrates only the location and orientation of the axes relative to the optical center. In contrast, a general formulation is adopted that does not make any of the above simplifications. The formulations as presented in this invention show that such simplifications are unnecessary, and that an assumption of a general configuration does not unduly increase the complexity of the solution.

The equation that relates a 3D world coordinate and a 2D camera coordinate for a pan-tilt PTZ camera is (See Davis and Chen):
Pᵣₑₐₗ={M_{real←ideal}(ƒ)M_{ideal←camera}Tₜ⁻¹(ƒ)Rₙ_{ₜ}(φ)Tₜ(ƒ)Tₚ⁻¹(ƒ)Rₙ_{ₚ}(θ)Tₚ(ƒ)M_{camera←world}}P_{world}=M_{real←world}(ƒ, θ, φ)P_{world}

Where θ denotes the pan angle and φ denotes the tilt angle while nₚ and nₜ denote the orientations of the pan and tilt axes, respectively. To execute the pan and tilt DOFs, a translation (Tₚ and Tₜ) from the optical center to the respective center of rotation is executed first, followed by a rotation around the respective axis, and then followed by a translation back to the optical center for the ensuing projection¹ Mathematically speaking, only the components of Tₚ and Tₜ that are perpendicular to nₚ and nₜ can be determined. The components parallel to nₚ and nₜ are not affected by the rotation, and hence will cancel out in the back-and-forth translations. The parameters Tₚ and Tₜ are expressed as functions of the camera zoom, because zoom moves the optical center and alters the distances between the optical center and the rotation axes.
¹ Mathematically speaking, only the components of Tₚ and Tₜ that are perpendicular to nₚ and nₜ can be determined. The components parallel to nₚ and nₜ are not affected by the rotation, and hence will cancel out in the back-and-forth translations.

For tilt-pan PTZ cameras, if there are pan and tilt operations, the order of calibrations is reversed. This is because the first platform, tilt, will move the whole upper assembly (the pan platform and the camera) as a unit, thus maintaining the position of the optical center relative to the axis of pan. This allows the calibration of Tₚ as a function of camera zoom only.

To calibrate a PTZ camera, two steps are needed: (1) calibrating the rotation angles: that is, if the realized angles of rotation ((θ_{realized} and φ_{realized}) are close to the requested ones (θ_{requested} and φ_{requested}), and (2) calibrating the location and orientation of the rotation axis.

The calibration procedure comprises two nested loops.
In the inner loop, the calibration processes execute a wide range of pan (or tilt) movements with a fixed camera zoom. It is first determined how faithfully the requested pan (or tilt) angles are actually realized by the camera unit. Interpolation processes are carried out to construct the functions θ_{realized}=ƒ(θ_{requested}) and φ_{realized}=g(φ_{requested}) The calibration processes further proceed with calibration of the rotation axis' location and orientation.
In the outer loop, the calibration processes vary the zoom setting of the camera and determine, for each selected zoom setting, the movement of the optical center. Hence, the relative positions (Tₚ and Tₜ) between the optical center and the rotation axes as functions of zoom is obtained. Again, interpolation process is carried out to construct the functions Tₚ(ƒ) and Tₜ(ƒ). The loop body comprises the following basic steps (illustrated here for calibrating the pan angles):
1. First, holding θ_{requested}=φ_{requested}=0 (or some selected angles), calibrate the dynamic camera using the stationary camera calibration procedure outlined in section 0. Denote the world-to-camera matrix thus obtained as M_{camera←world}(0, ƒ).
2. Moving θ_{requested} to some known angle (but keeping φ_{requested} fixed), calibrate the dynamic camera again using the previous procedure. Denote the world-to-camera matrix thus obtained as M_{camera←world}(θ_{realized}, ƒ)
Then it is easily shown that

$${M}_{camera ← world} ( {θ}_{realized} , f ) = {T}_{p}^{- 1} ( f ) {R}_{{n}_{p}} ( {θ}_{realized} ) {T}_{p} ( f ) {M}_{camera ← world} ( 0 , f )$$

$${T}_{p}^{- 1} ( f ) {R}_{{n}_{p}} ( {θ}_{realized} ) {T}_{p} ( f ) = {M}_{camera ← world} ( {θ}_{realized} , f ) {M}_{world ← camera} ( 0 , f )$$

$$\begin{matrix}{T}_{p}^{- 1} ( f ) {R}_{{n}_{p}} ( {θ}_{realized} ) {T}_{p} ( f ) = [ \begin{matrix}1 & 0 & 0 & {T}_{x} \\ 0 & 1 & 0 & {T}_{y} \\ 0 & 0 & 1 & {T}_{z} \\ 0 & 0 & 0 & 1\end{matrix} ] [ \begin{matrix}{r}_{1}^{T} & 0 \\ {r}_{2}^{T} & 0 \\ {r}_{3}^{T} & 0 \\ 0 & 1\end{matrix} ] [ \begin{matrix}1 & 0 & 0 & - {T}_{x} \\ 0 & 1 & 0 & - {T}_{y} \\ 0 & 0 & 1 & - {T}_{z} \\ 0 & 0 & 0 & 1\end{matrix} ] \\ = [ \begin{matrix}{r}_{1}^{T} & - {T}_{p} \cdot {r}_{1} + {T}_{x} \\ {r}_{2}^{T} & - {T}_{p} \cdot {r}_{2} + {T}_{y} \\ {r}_{3}^{T} & - {T}_{p} \cdot {r}_{3} + {T}_{z} \\ 0 & 1\end{matrix} ]\end{matrix}$$

$$Denote {M}_{camera ← world} ( {θ}_{realized} , f ) {M}_{world ← camera} ( 0 , f ) as [ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ 0 & 0 & 0 & 1\end{matrix} ] ,$$

and simple manipulation reveals Error! Reference source not found.

$${n}_{{p}_{x}} = \frac{{m}_{32} - {m}_{23}}{4 w \sqrt{( 1 - {w}^{2} )}} , {n}_{{p}_{y}} = \frac{{m}_{13} - {m}_{31}}{4 w \sqrt{( 1 - {w}^{2} )}} , {n}_{{p}_{z}} = \frac{{m}_{21} - {m}_{12}}{4 w \sqrt{( 1 - {w}^{2} )}} {θ}_{realized} = 2 {cos}^{- 1} w$$

$$where w = \sqrt{\frac{{\sum }_{i = 1}^{4} {m}_{ii}}{4}}$$

And T to be solved by a system of three linear equations −Tₚ·r₁+Tₓ=m₁₄, −Tₚ·r₂+T_{y}=m₂₄, and −Tₚ·r₃+T_{z}=m₃₄.

In general, this calibration procedure should be carried out multiple times with different θ_{requested} settings. The axis of rotation and the center of location should be obtained by averaging of multiple calibration trials. The relationship of the requested angle of rotation and the executed angle of rotation, i.e., θ_{realized}=ƒ(θ_{requested}) can be interpolated from multiple trials using a suitable interpolation function ƒ (e.g., a linear, quadratic, or sigmoid function).

On-Line Selective Focus-of-Attention

Once a potential suspect (e.g., person/vehicle) has been identified in a stationary camera, the next step is often to relay discriminative visual traits of the suspect (RGB and texture statistics, position and trajectory, etc.) from the stationary camera to a dynamic camera. The dynamic camera then uses its pan, tilt, and zoom capabilities for a closer scrutiny.

To accomplish the selective focus-of-attention feat, it is required to (1) identify the suspect in the field-of-view of the dynamic camera, and (2) manipulate the camera's pan, tilt, and zoom mechanisms to continuously center upon and present a suitably sized image of the subject.

The first requirement is often treated as a correspondence problem, solved by matching regions in the stationary and dynamic cameras based on similarity of color and texture traits, congruency of motion trajectory, and affirmation of geometrical epipolar constraints. As there are techniques available to provide solutions for implementation in the surveillance of this application, for the sake of simplicity and clarity, the details will not described here.

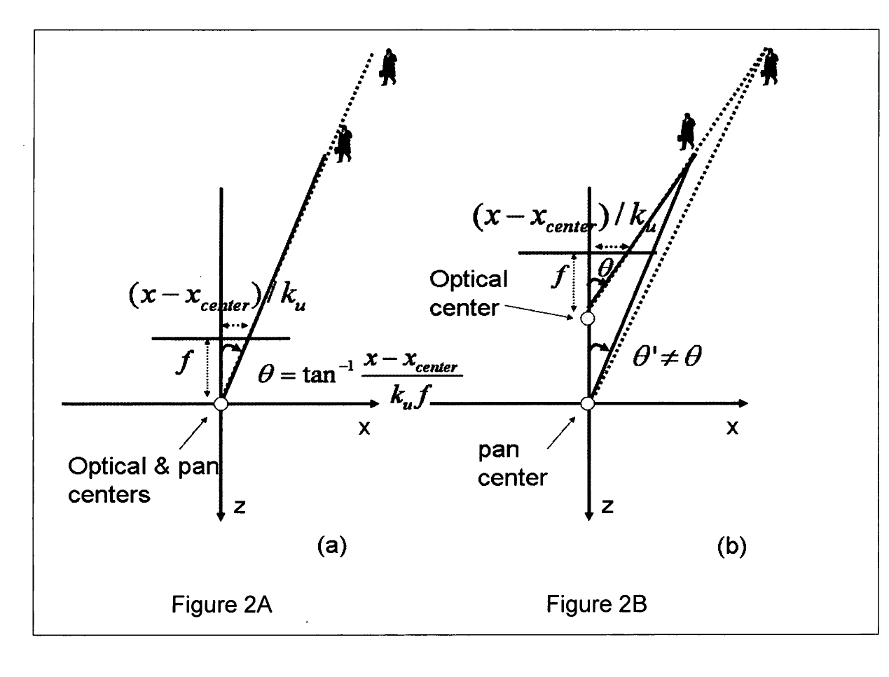

As to the second requirement, there is in fact a trivial solution if the optical center of the PTZ camera is located on the axes of pan and tilt, and if the axes are aligned with the width and height of the CCD. FIG. 2 illustrates this trivial solution for the pan DOF, that shows a cross section of the 3D space that is perpendicular to the pan axis. Assume for the sake of simplicity that the pan axis is the y (vertical) axis. Then the cross section corresponds to the z-x plane in the camera's frame of reference, with the optical center located at the origin. The x coordinate of the tracked object can then be used for calculating the pan angle as θ=arctan{(x-x_{center})/(kuƒ)}, where x_{center} is the x coordinate of the center of the image plane. As can be seen from FIG. 2 the collocation of the optical center and the pan axis ensures that the camera pan will not move the optical center. In this case, the selective focus-of-attention processes achieve the desired centering effect without needing to know the depth of the tracked object. As shown in FIG. 2, the pan angle is the same regardless of the depth of the suspect.

In reality, however, the optical center is often not located on the rotation axis. As illustrated in FIG. 2B, even when the axes are aligned with the CCD, the pan angle as computed above (θ) will not be the correct rotation angle (θ′). A moment's thought should reveal the impossibility of computing the correct θ′ without knowing the depth of the subject. This is illustrated in FIG. 2B, where the pan angle is shown to be a function of the depth of the subject.

In more detail, if it is assumed that the optical center and the centers of pan and tilt are collocated, and the axes align with the CCD as in FIG. 2A calculation of the pan angle as arctan{(x-x_{center})/(ku ƒ)} is processed to center the object in the dynamic camera. In reality, however, the optical center and the centers of pan and tilt may not be collocated, and if so, the angle thus calculated will not be entirely correct as shown in 2B. Executing the rotation maneuver will therefore not center the object. But a determination is required to find out how large can the error (θ′) be, and how does that translate into real-world pixel error.

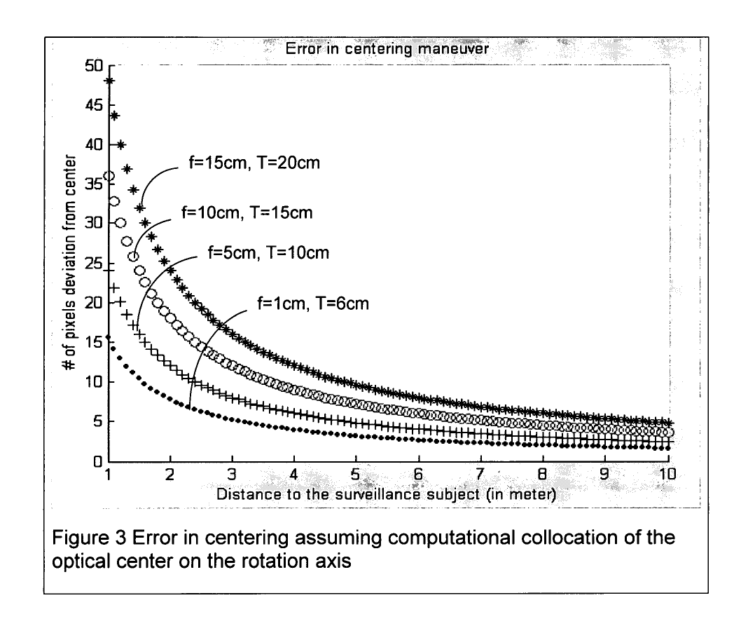

FIG. 3 shows the pixel centering error as a function of the object distance for four different settings of focal length (ƒ) and distance from the optical center to the pan (or tilt) axis (T). In the simulation, the selective focus-of-attention processes use real-world camera parameters of a Sony PTZ camera (Sony Coop. “Sony EVI-D30 Pan/Tilt/Zoom Video Camera User Manual,” 2003), where the CCD array size is ⅓″ with about 480 pixels per scan line. The object can be as far as 10 meters, or as close as 1 meter, from the camera. The focal length can be as short as 1 cm (with >50° wide fields-of-view) or as long as 15 cm (with 5° narrow fields-of-view). Inasmuch as the location of the CCD array is fixed, changing the focal length will displace the optical center, thus altering the distance between the optical center and the axes. It is further assumed that a fixed displacement from the rotation axes to the CCD array to be about 4 cm, which corresponds to the real-world value for the Sony PTZ cameras. As can be seen, the centering error is small (less than 5 pixels but never zero) when the object is sufficiently far away. The centering error becomes unacceptable (>20 pixels) when the object is getting closer (around 3 m) even with a modest zoom setting². Obviously, then, a much more accurate centering algorithm is needed.
² While 3 m may sound short, one has to remember that dynamic cameras need to operate at high zoom settings for close scrutiny. At a high zoom setting, the effective depth of the object can and do become very small.

It might seem that the centering problem could be solved if the centering processes either (1) adopt a mechanical design that ensures collocation of the optical center on the rotation axes, or failing that, (2) infer the depth of the subject to compute the rotation angle correctly. However, both solutions turn out to be infeasible for the following reasons:
In reality, it is often impossible to design a pan-tilt platform mechanically to ensure that the optical center falls on the rotation axes. To name a few reasons: (1) The two popular mechanical designs as described above have separate pan and tilt mechanisms, and the rotation axes are displaced with respect to each other. The optical center cannot lie on both axes at the same time. (2) A less accurate approach is to use a ball (or a socket) joint. Ball joints are not very desirable. It does appear that there are any commercial powered PTZ cameras that adopt this particular design—because of potential mechanical slippage and free play that degrade pan-and-tilt accuracy. Even with a ball joint where both the pan and tilt axes pass through the center, it is still difficult to position the camera (and the optical center) correctly inside the ball joint. (3) Finally, even if it were possible to use a ball joint and position the optical center optimally for a particular zoom setting, different zoom settings could displace the optical center.
Depth information is critical for computing the correct pan-and-tilt angles. However, such information is only a necessary, not a sufficient condition. Although the pan angle can be uniquely determined from the x displacement and object depth in the simple configuration in FIG. 2B generally nonzero pan-and-tilt angles will affect both x and y image coordinates. This is because when a pan-tilt camera is assembled, some nonzero deviation is likely in the orientation of the axes with respect to the camera's CCD. Mathematically, one can verify this coupling by multiplying the terms in Eq. 1 T₁⁻¹(ƒ)Rₙ_{ₜ}(φ)Tₜ(ƒ)Tₚ⁻¹(ƒ)Rₙ_{ₚ}(θ)Tₚ(ƒ) and noting that and have each appeared in both of the (decidedly nonlinear) expressions for x and y e coordinates.

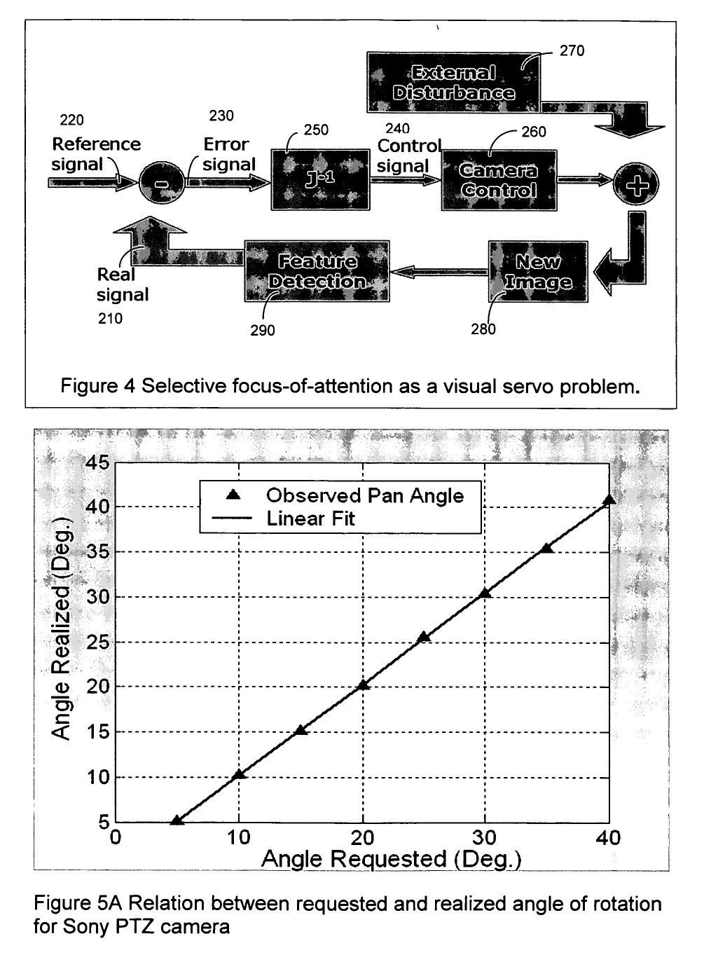

Instead, the present invention formulates this selective, purposeful focus-of-attention problem as one of visual servo. Referring to FIG. 4 as a diagram for describing the formulation of a solution to deal with the selective, purposeful focus-of-attention processes as one of visual servo. The visual servo framework is modeled as a feedback control loop. This servo process is repeated over time. At each time instance, the master camera will perform visual analysis and identify the current state, e.g., position and velocity, of the suspicious persons or vehicles. A similar analysis is performed at the slave cameras under the guidance of the master. Image features, e.g., position and size of the license plate of a car or the face of a person, of the subjects are computed and serve as the input to the servo algorithm, i.e., the real signals 210. The real signals are then compared with the reference signals 220, which specify the desired position, e.g., at the center of the image plane, and size, e.g. covering 80% of the image plane, of the image features. Deviation between the real and reference signals generates an error signal 230 that is then used to compute a camera control signal 240, i.e., desired changes in the pan, tilt, and zoom DOFs. Executing these recommended changes 250 to the camera's DOFs 260 will train and zoom the camera to minimize the discrepancy between the reference and real signals, i.e., to center the subject with a good size. Finally, as generally there is no control over the movements of the surveillance subjects, such movements must be considered as external disturbance 270, i.e., noise, in the system. Combination and integration of these input parameters are applied to generate new image 280 and feature detection output 290 as the real signal 210 to start the next iteration of feedback loop analysis. This loop of video analysis to generate the new image 280, feature extraction, feature comparison, and camera control (servo) as shown in FIG. 4 is then repeated for the next time frame.

As mentioned, the stationary cameras perform visual analysis to identify the current state (RGB, texture, position, and velocity) of the suspicious persons/vehicles. A similar analysis is performed by the dynamic cameras under the guidance of the stationary camera. Image features of the subjects (e.g., position and size of a car license plate or the face of a person) are computed and then serve as the input to the servo algorithm (the real signals). The real signals are compared with the reference signals, which specify the desired position (e.g., at the center of the image plane) and size (e.g., covering 80% of the image plane) of the image features. Deviation between the real and reference signals generates an error signal that is used to compute a camera control signal (i.e., desired changes in the pan, tilt, and zoom DOFs). Executing these recommended changes to the camera's DOFs will train and zoom the camera to minimize the discrepancy between the reference and real signals (i.e., to center the subject with a good size). Finally, as there is no control over the movements of the surveillance subjects, such movements must be considered external disturbance (noise) in the system. This loop of video analysis, feature extraction, feature comparison, and camera control (servo) is then repeated for the next time frame. This seems to be a reasonable formulation as the dynamic and incremental nature of the problem is considered.

The video analysis and feature extraction processes are not described here because there are many standard video analysis, tracking, and localization algorithms that can accomplish these. Instead, the descriptions in this section discuss the detail of how to generate the camera control signals below, assuming that features have already been extracted from the stationary and dynamic cameras.

Visual servo is based on Eq. 1 that relates the image coordinate to the world coordinate for PTZ cameras. Assume that samples are taken at the video frame rate (30 frames/second) and at a particular instant it is observed that the tracked object at a certain location in the dynamic camera. Then, the questions addressed here are:
1. Generally, what is the effect of changing the camera's DOF (ƒ, θ, φ) on the tracked object's 2D image location?
2. Specifically, how can the camera's DOFs be manipulated to center the object?

One can expect, by a cursory examination of Equation 1, that the relationship between image coordinates and the camera's DOFs to be fairly complicated and highly nonlinear. Hence, a closed-form solution to the above two questions is not likely. Instead, the formulations are linearized by rearranging terms in Equation 1 and taking the partial derivative of the resulting expressions with respect to the control variables ƒ, θ, φ:

$$\begin{matrix}{x}_{real} = {fk}_{u} \frac{{x}_{ideal}}{{z}_{ideal}} + {u}_{o} {y}_{real} = {fk}_{v} \frac{{y}_{ideal}}{{z}_{ideal}} + {v}_{o} \\ {dx}_{real} = {k}_{u} \frac{{x}_{ideal}}{{z}_{ideal}} df + {fk}_{u} ( \partial \frac{{x}_{ideal}}{{z}_{ideal}} / \partial θ ) d θ + {fk}_{u} ( \partial \frac{{x}_{ideal}}{{z}_{ideal}} / \partial ϕ ) d ϕ \\ {dy}_{real} = {k}_{v} \frac{{y}_{ideal}}{{z}_{ideal}} df + {fk}_{v} ( \partial \frac{{y}_{ideal}}{{z}_{ideal}} / \partial θ ) d θ + {fk}_{v} ( \partial \frac{{y}_{ideal}}{{z}_{ideal}} / \partial ϕ ) d ϕ & ( 1 ) \\ [ \begin{matrix}{dx}_{real} \\ {dy}_{real}\end{matrix} ] = [ \begin{matrix}{k}_{u} \frac{{x}_{ideal}}{{z}_{ideal}} & {fk}_{u} ( \partial \frac{{x}_{ideal}}{{z}_{ideal}} / \partial θ ) & {fk}_{u} ( \partial \frac{{x}_{ideal}}{{z}_{ideal}} / \partial ϕ ) \\ {k}_{v} \frac{{y}_{ideal}}{{z}_{ideal}} & {fk}_{v} ( \partial \frac{{y}_{ideal}}{{z}_{ideal}} / \partial θ ) & {fk}_{v} ( \partial \frac{{y}_{ideal}}{{z}_{ideal}} / \partial ϕ )\end{matrix} ] [ \begin{matrix}df \\ d θ \\ d ϕ\end{matrix} ] = J [ \begin{matrix}df \\ d θ \\ d ϕ\end{matrix} ] & ( 2 )\end{matrix}$$

The expression of J is a little bit complicated and will not be presented here to save space. However, it is a simple mathematic exercise to figure out the exact expression. The expression in Eq. 3 answers the first question posed above. The answer to the second question is then obvious: the formulations of this invention substitute [x_{center}-x, y_{center}-y]^{T} for [dxᵣₑₐₗ, dyᵣₑₐₗ]^{T} in Eq. 3 because that is the desired centering movement. However, as Eq. (3) represents a linearized version of the original nonlinear problem (or its first-order Taylor series expansion), iterations are needed to converge to the true solution. Actually the need for iterations does not present a problem, since computation is efficient and convergence is fast even with the simple Newton's method. In the experiments discussed below, convergence is always achieved within four iterations with ˜ 1/10,000 of a pixel precision. Two final points worth mentioning are
First, there are two equations (in terms of x and y displacements) and three variables (ƒ, θ, φ). Hence, it is not possible to obtain a unique solution. The formulation will manipulate (θ, φ) to control (x, y) to achieve the desired centering results. Once the object is centered, the selective focus-of-attention formulations use _{(ƒ)} to control the change in the object's size. That way, there are two DOFs with two equations to center a tracked object:

$$[ \begin{matrix}{dx}_{real} \\ {dy}_{real}\end{matrix} ] = [ \begin{matrix}{fk}_{u} ( \partial \frac{{x}_{ideal}}{{z}_{ideal}} / \partial θ ) & {fk}_{u} ( \partial \frac{{x}_{ideal}}{{z}_{ideal}} / \partial ϕ ) \\ {fk}_{v} ( \partial \frac{{y}_{ideal}}{{z}_{ideal}} / \partial θ ) & {fk}_{v} ( \partial \frac{{y}_{ideal}}{{z}_{ideal}} / \partial ϕ )\end{matrix} ] [ \begin{matrix}d θ \\ d ϕ\end{matrix} ] = {J}_{center} [ \begin{matrix}d θ \\ d ϕ\end{matrix} ]$$

It is easy to verify that Jacobian J_{center} is well conditioned and invertible using an intuitive argument. This is because the two columns of the Jacobian represent the instantaneous image velocities of the tracked point due to a change in the pan (θ) and tilt (φ) angles, respectively. As long as the instantaneous velocities are not collinear, J_{center} has independent columns and is therefore invertible. It is well known that degeneracy can occur only if a “gimbal lock” condition occurs that reduces one DOF. For pan-tilt cameras, this occurs only when the camera is pointing straight up. In that case, the pan DOF reduces to a self-rotation of the camera body, which can make some image points move in a way similar to that under a tilt maneuver. This condition rarely occurs; in fact, it is not even possible for Sony PTZ cameras because the limited range of tilt does not allow the camera to point straight up.
Second, to uniquely specify the Jacobian, it is necessary to know the depth of the object. With the collaboration of stationary and dynamic cameras, it is possible to use standard stereo triangulation algorithms to obtain at least a rough estimate of the object depth.
   Experimental Results

This section describes the results in both off-line calibration and on-line selective focus-of-attention. For the off-line calibration, the traditional method is adopted to construct a planar checkerboard pattern and then placing the pattern at different depths before the camera to supply 3D calibration landmarks. As discussed above, while Davis and Chen advocates a different method of generating virtual 3D landmarks by moving an LED around in the environment, it is found that method to be less accurate.

The argument used in Davis and Chen to support the virtual landmark approach is the need of a large working space to fully calibrate the pan and tilt DOFs. While this is true, there are different ways to obtain large angular ranges. Because θ≈r/d, a large angular range can be achieved by either (1) placing a small calibration stand (small r) nearby (small d) or (2) using dispersed landmarks (large r) placed far away (large d). While Davis and Chen advocates the latter, the former approach is adopted.

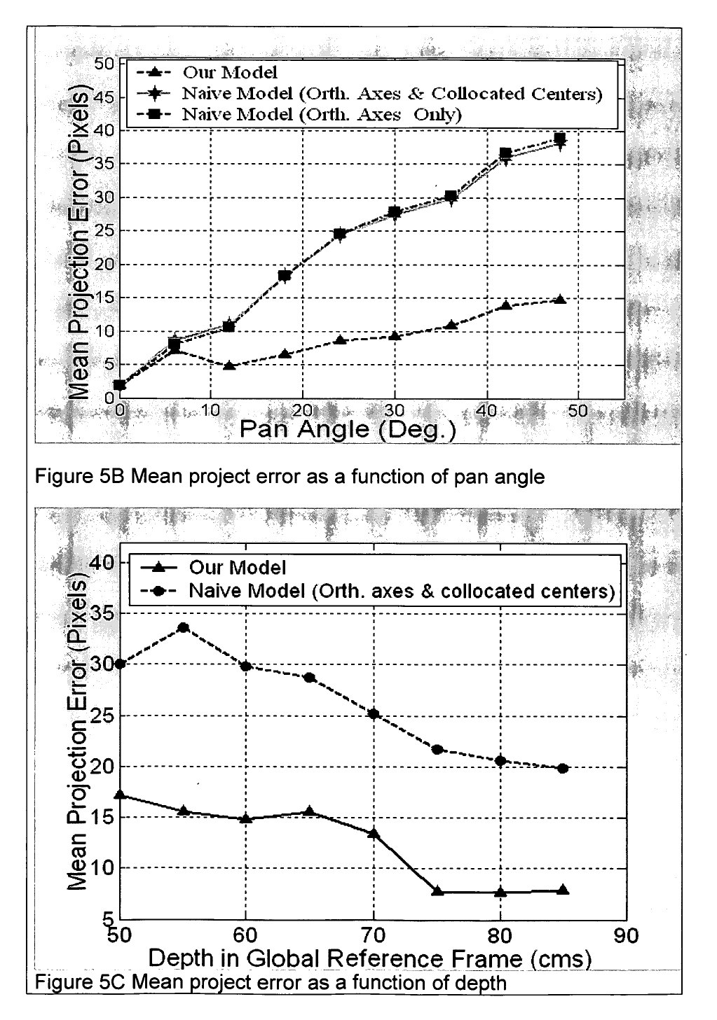

The reason here is that to calibrate Tₚ and Tₜ accurately, it is desirable that their effects to be as pronounced as possible and easily observable in image coordinates. This makes a near-field approach better than a far-field approach. As seen in FIG. 5, when the object distance gets larger, whether or not the optical center is collocated with the axes of pan and tilt (Tₚ and Tₜ) becomes less consequential. Coupled with the localization errors in 3D and 2D landmarks, this makes it extremely difficult to calibrate Tₚ and Tₜ accurately using the approach presented in Davis and Chen. It is found from the experiments that using landmarks placed far away often yielded widely varying results for Tₚ and Tₜ from one run to the next. Hence, the disclosures of this invention do not advocate the approach taken in Davis and Chen.

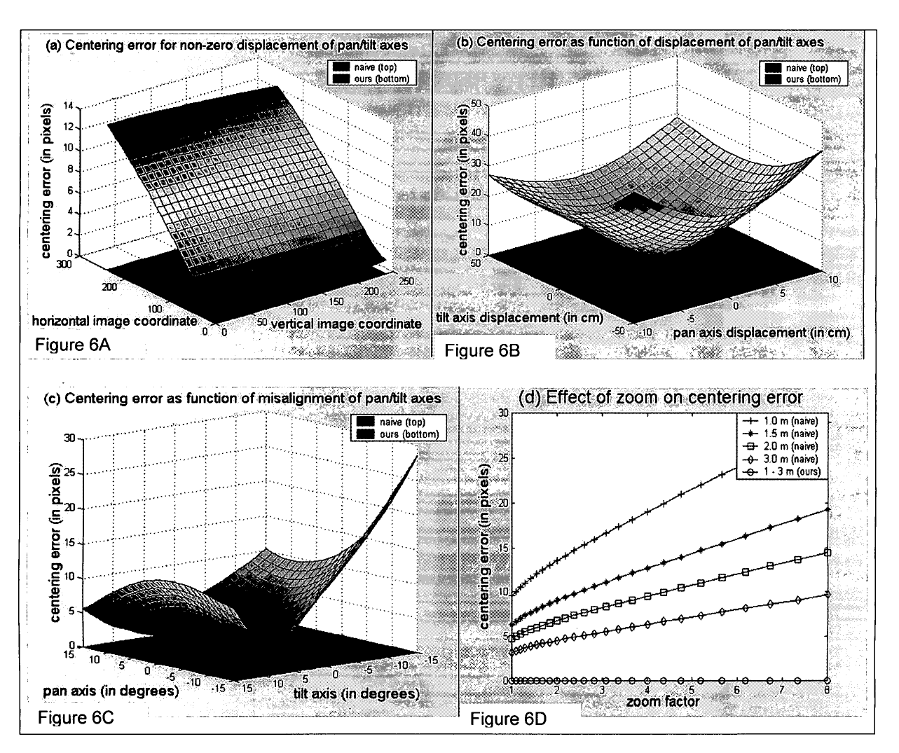

Off-line calibration: Results are summarized in FIGS. 6A to 6D the measurements are obtained by using the Sony EVI-D30 cameras in all the experiments. The image size used in all the experiments is 768×480 pixels.

FIG. 6A show the calibration results for θ_{realized}=ƒ(θ_{requested}) and the best linear fit. As can be seen, the realized pan angles match well with the requested angles even for large rotations. Similar good results are obtained for θ_{realized}=g(θ_{requested}) (not shown here). To estimate Tₚ(f) the calibration procedures are repeated for a wide range of pan angles (θ=5° to 40° in 5° increment). The final Tₚ values are obtained by averaging the Tₚ values for different pan angles. The values for Tₜ are obtained in a similar fashion. For Sony cameras, the results show that the axes are well aligned with the camera's CCD. Hence, the method is useful for validating good mechanical designs. It also enables the use of less expensive and less accurate motorized mounts for maneuvering dynamic cameras.

In FIGS. 6B and 6C comparisons of the model as disclosed in this invention with two naïve models: one assuming collocated centers (i.e., the optical center is located on the pan and tilt axes) and orthogonal axes (i.e., the axes are aligned with the CCD), and the other assuming independent centers but orthogonal axes. The mean projection errors in FIGS. 6B and 6C are obtained for all three models (ours and two naïve ones) by (1) mathematically projecting 3D calibration landmarks onto the image plane using the camera parameters computed based on these three models, and (2) comparing the observed landmark positions with the mathematic predictions and averaging the deviations. FIG. 6B shows the mean projection error as a function of pan angle. As seen in FIG. 6B, the performance of the naïve models is much worse than the results obtained by applying the methods disclosed in this invention. FIG. 6B suggests that the naïve models could completely lose track of an object at high zoom. At a pan angle of 45° the projection error of the naïve models can be as large as 38 pixels at ˜1 m!

FIG. 6C shows the mean projection error as the depth of the calibration landmarks from the camera changes. As evident the projection error gets smaller as the object moves further away from the camera. However even at large distances the performance of the model as implemented in this invention is much better than that of the naïve approaches. It could be argued that a correct model like the present invention is important only when the object is close to the camera. However, surveillance cameras often have to zoom at a high value (as high as 20×). In such cases the object appears very close to the camera, and the projection error once again becomes unacceptable for the naïve models.

On-line focus-of-attention: experiments are conducted using both synthesized and real data. For synthesized data, comparisons are made between the accuracy of the algorithm disclosed in this invention with that of a näive centering algorithm. The naïve algorithm makes the following assumptions: (1) the optical center is collocated on the axes of pan and tilt, and (2) the pan DOF affects only the x coordinates whereas the tilt DOF affects only the y coordinates. While those assumptions are not generally valid, algorithms making those assumptions can and do serve as good baselines because they are very easy to implement, and they give reasonable approximations for far-field applications.

In more detail the naïve algorithm works as follow: Assume that a tracked object appears in the dynamic camera at location p_{ideal}=[X_{ideal}/z_{ideal}, y_{ideal}/z_{ideal}, 1]^{T} as defined in Eq. 2. The pan rotation in the y direction is applied as p_{ideal}=R_{y}(θ)p_{ideal}, and tilt rotation in the x direction as p″_{ideal}=Rₓ(φ)p′_{ideal}, where θ=tan⁻¹((x-x_{center})/(kᵤƒ)) and φ=tan⁻¹((y′-y_{center})/(kᵥƒ)). To make the simulation realistic, the parameters of Sony PTZ cameras are used.

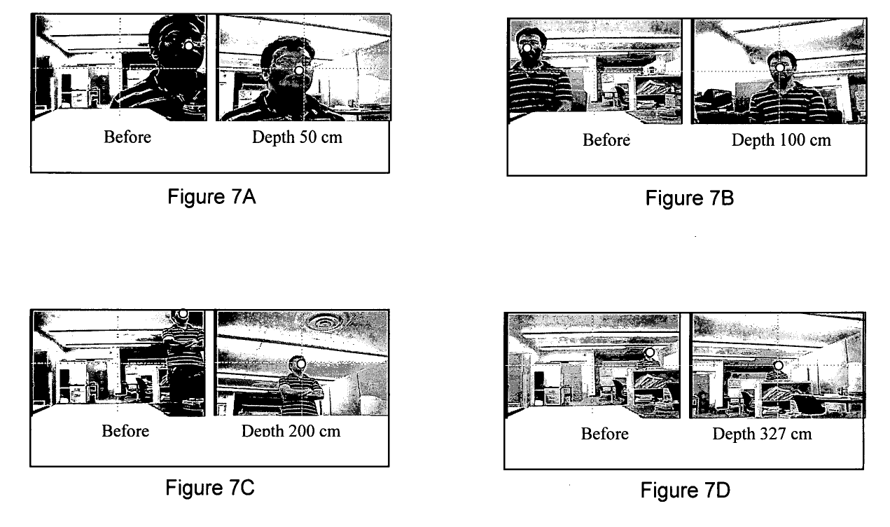

FIG. 7A compares the centering error (in pixels) of the method of this invention and the naïve method with different starting image positions. Here it is assumed that the distances from the optical center to the panning and tilt axes are 5 cm (Tₚ) and 2.5 cm (Tₜ), respectively. These values are chosen to be similar to those of Sony cameras. A depth of ˜1 m is assumed. The error when applying the method disclosed in this invention is less than 0.1 pixels for any starting point and convergence is always achieved in 4 iterations or less. By contrast, the naïve method, which does not take into account the displacement of the pan/tilt axes from the optical center, can be seen to center the point inaccurately, with errors as large as 14 pixels. FIG. 7B shows similar results as 7A, except that a single starting location is assumed (the upper-left corner of the image) and the centering error is displayed as a function of the displacements of the pan and tilt axes.

Another source of error of the naïve method involves the possible misalignment of the pan/tilt axes. While the naïve method assumes that the axes are perfectly aligned with the CCD, in reality some deviation can and should be expected. The method incorporates this deviation information into the equations and thus avoids this additional source of error that leads to inaccurate centering. FIG. 7C compares the accuracy of the present method and the naïve method when axes are not perfectly aligned. This model uses a single starting location and plots centering error as a function of the misalignment of the pan and tilt axes. Again, the method gives almost perfect results while the naïve algorithm gives results that are highly sensitive to error in axes alignment.

FIG. 7D exhibits the effect of introducing zoom. Intuitively, it makes sense that increasing zoom, for a given object depth, will cause the error of the naïve method to increase. This can be understood as zoom causing an object's effective depth to decrease. A smaller effective depth means that the effect of a non-zero pan/tilt axis displacement will be more significant to the centering problem. In this graph, the centering error is plotted as a function of zoom factor for various depths, and, as anticipated, increasing zoom lowers the accuracy of the naïve-centering algorithm. Thus, it is clear that when the camera exploits its zoom capabilities (as is typically the case for surveillance), the use of a precise centering algorithm becomes even more critical.

The experiments further test the performance of the centering algorithm on real data as well. A person is made to stand in front of the camera at an arbitrary position in the image frame. The centering algorithm then centers the tip of the nose of the person and shows the centering is achieved using the method disclosed in this invention The center of the screen has been marked by dotted white lines and the nose tip by the white circle, both before and after centering. The centering error reduces as the object gets farther away from the camera; however, the centering results are good even when the object (the face) gets as close as 50 cm to the camera.

According to above descriptions, this invention further discloses an alternate embodiment of a video surveillance camera that includes a global large-filed-of-view surveillance lens and a dynamic selective-focus-of-attention surveillance lens. The video surveillance camera further includes an embedded controller for controlling the video surveillance camera to implement a cooperative and hierarchical control process for operating with the global large-filed-of-view surveillance lens and the dynamic selective-focus-of-attention surveillance lens. In a preferred embodiment, the video surveillance camera is mounted on a movable platform. In another preferred embodiment, the video surveillance camera has flexibility of multiple degrees of freedom (DOFs). In another preferred embodiment, the controller is embodied in the camera as an application specific integrated circuit (ASIC) processor.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A video surveillance system comprising:
at least two video cameras performing a surveillance by using a cooperative and hierarchical control process.

2. The video surveillance system of claim 1 wherein:
said two video cameras comprising a first video camera functioning as a master camera for commanding a second video camera functioning as a slave camera.

3. The surveillance system of claim 1 wherein:
said two cameras further controlled by a control processor.

4. The surveillance system of claim 1 wherein:
said two cameras further controlled by a control processor embodied in a computer.

5. The surveillance system of claim 1 wherein:
at least one of said cameras are mounted on a movable platform.

6. The surveillance system of claim 1 wherein:
at least one of said cameras having a flexibility of multiple degrees of freedom (DOFs).

7. The surveillance system of claim 1 wherein:
at least one of said cameras having a rotational flexibility for pointing to different angular directions.

8. The surveillance system of claim 1 wherein:
at least one of said cameras having an automatically adjustable focus length.

9. The surveillance system of claim 1 wherein:
at least one of said cameras is provided to receive a command from anther camera to automatically adjust a focus length.

10. The surveillance system of claim 1 wherein:
said surveillance comprises at least three cameras configured in a co-linear configuration.

11. The surveillance system of claim 1 wherein:
said surveillance comprises at least three cameras configured in a planar configuration.

12. The surveillance system of claim 1 wherein:
said surveillance comprises at least three cameras with one master camera and two slave cameras disposed on either sides of said master camera.

13. A video surveillance system comprising:
a controller controlling a camera for performing a stationary global large-filed-of-view surveillance and a dynamic selective-focus-of-attention surveillance by implementing a cooperative and hierarchical control process.

14. The video surveillance system of claim 13 wherein:
said cooperative and hierarchical control process controlling said camera to function as a stationary camera to carry out said global large-field-of-view surveillance and dynamic camera to carry out said selective-focus-of-attention surveillance.

15. The surveillance system of claim 13 wherein:
said controller is embodied in a computer.

16. The surveillance system of claim 13 wherein:
said camera is mounted on a movable platform.

17. The surveillance system of claim 13 wherein:
said camera having a flexibility of multiple degrees of freedom (DOFs).

18. The surveillance system of claim 13 wherein:
said controller is embodied in said camera as an embedded processor.

19. A video surveillance system for a large area comprising several compartmentalized zones comprising:
a stationary video camera for monitoring said large area and at least two dynamic video cameras for monitoring said several compartmentalized zones wherein said global video camera and said dynamic video cameras are operated according to a cooperative and hierarchical control process.

20. The video surveillance system of claim 19 wherein:
said stationary video camera functioning as a master camera for commanding said dynamic video cameras functioning as slave cameras.

21. The surveillance system of claim 19 wherein:
said stationary camera and said dynamic cameras are further controlled by a control processor.

22. The surveillance system of claim 19 wherein:
said stationary camera and said dynamic cameras are further controlled by a control processor embodied in a computer.

23. The surveillance system of claim 19 wherein:
at least one of said video cameras are mounted on a movable platform.

24. The surveillance system of claim 19 wherein:
at least one of said video cameras having a flexibility of multiple degrees of freedom (DOFs).

25. The surveillance system of claim 19 wherein:
at least one of said video cameras having a rotational flexibility for pointing to different angular directions.

26. The surveillance system of claim 19 wherein:
at least one of said video cameras having an automatically adjustable focus length.

27. The surveillance system of claim 19 wherein:
at least one of said dynamic cameras is provided to receive a command transmitted as wireless signals from said stationary camera.

28. The surveillance system of claim 19 wherein:
said stationary video camera and said dynamic video cameras are configured in a co-linear configuration.

29. The surveillance system of claim 19 wherein:
said stationary video camera and said dynamic video cameras are configured in a planar configuration.

30. The surveillance system of claim 19 wherein:
said stationary camera and said dynamic cameras are further controlled by a control processor embodied in said stationary video camera.

31. A video surveillance camera comprising:
a global large-filed-of-view surveillance lens and a dynamic selective-focus-of-attention surveillance lens; and
an embedded controller for controlling said video surveillance camera to implement a cooperative and hierarchical control process for operating with said global large-filed-of-view surveillance lens and said dynamic selective-focus-of-attention surveillance lens.

32. The video surveillance camera of claim 31 wherein:
said camera is mounted on a movable platform.

33. The video surveillance camera of claim 31 wherein:
said camera having a flexibility of multiple degrees of freedom (DOFs).

34. The video surveillance camera of claim 31 wherein:
said controller is embodied in said camera as an application specific integrated circuit (ASIC) processor.
